(19) United States
(12) Patent Application Publication
(10) Pub. No.: US 2016/0378231 A1
(43) Pub. Date: Dec. 29, 2016

(54) DISPLAY DEVICE

(71) Applicant: Samsung Electronics Co., Ltd., Gyeonggi-do (KR)

(72) Inventors: Min Uk KIM, Gyeonggi-do (KR); Jung Won KIM, Gyeonggi-do (KR); Hakyeol KIM, Gyeonggi-do (KR); Woo-Young OH, Gyeonggi-do (KR); Song Hee JUNG, Gyeonggi-do (KR); Keunsik LEE, Gyeonggi-do (KR)

(21) Appl. No.: 15/189,256

(22) Filed: Jun. 22, 2016

(30) Foreign Application Priority Data
Jun. 23, 2015 (KR) 10-2015-0089083

(51) Int. Cl. G06F 3/041; G06F 3/044; G02B 27/28

(52) U.S. Cl. CPC G06F 3/0412; G02B 27/286; G06F 3/044; G06F 2203/04102; G06F 2203/04107

(57) ABSTRACT

A slim display device is disclosed in the present disclosure. The disclosed display device may include: a window having a printed area formed along an outer periphery thereof, a display panel disposed below the window to provide a view area including an active area where data is displayed and a non-active area, and a touch detection unit disposed between the window and the display panel, wherein a plurality of electrode trace patterns of the touch detection unit are disposed under the non-active area.

### CLAIM OF PRIORITY

This application claims the priority under 35 U.S.C. §119(a) to Korean Application Serial No. 10-2015-0089083, which was filed in the Korean Intellectual Property Office on Jun. 23, 2015, the entire content of which is hereby incorporated by reference.

### TECHNICAL FIELD

Various embodiments of the present disclosure relate to a display device that is mounted on a portable electronic device.

### BACKGROUND

Display devices are used in electronic devices to display information to the user. Generally, flat panel displays are used and are generally mounted on the electronic devices.

Particularly, in recent years, flexible displays enable users to see information and/or manipulate user interfaces through touches on the screens. These flexible displays may be curved, bent, folded, or rolled and have attracted a lot of attention as display devices for electronic devices.

In general, flexible displays may collectively refer to displays that are formed on substantially flexible substrates. These flexible displays are manufactured with flexible substrates, such as a plastic substrate, etc., and may be curved, bent, or rolled without damage by virtue of the substrates, which are thin and flexible. These displays also have impact resistance, flexibility, and toughness while maintaining existing screen characteristics.

Thin film transistor liquid crystal displays (TFT-LCDs), organic light emitting diodes (OLEDs), or electrophoretic displays (EPDs) are mainly used in order to implement these flexible displays.

These display devices may be provided with touch screen panels (specifically, touch screen panels formed of Indium Tin Oxide (ITO) panels) for recognizing touches.

Touch screen panels are input devices that enable users to input commands by selecting instructions displayed on touch screens with their hands or objects.

To this end, the touch screen panels are provided on the front sides of the display devices to convert the contact locations of the users' hands or objects into electrical signals. The touch screen panels may be used as substitute for other input devices such as keyboards, mice, etc. to allow for ease of use.

Touch screen panels are known to be implementing using resistive, photo detective, capacitive, or other technology. The capacitive type touch screen panel converts a contact location into an electrical signal by detecting a change in capacitance that a conductive sensing pattern forms together with another sensing pattern or a ground electrode when a user's hand or object makes contact with the capacitive touch screen panel.

### SUMMARY

Various embodiments of the present disclosure may provide a display device that has a reduced black matrix (BM) area or non-active area of the display.

Various embodiments of the present disclosure may provide a slim display device.

A display device, according to one embodiment of the present disclosure, may include: a window having a printed area formed along an outer periphery thereof, a display panel disposed below the window to provide a view area including an active area where data is displayed and a non-active area, and a touch detection unit disposed between the window and the display panel, wherein a plurality of electrode trace patterns of the touch detection unit are disposed under the non-active area.

Further, a display device, according to one embodiment of the present disclosure, may include: a window having a printed area formed along an outer periphery thereof, a display panel disposed below the window to provide a view area including an active area where data is displayed and a non-active area, a touch detection unit disposed on the display panel, the touch detection unit includes a transparent substrate, an electrode pattern disposed on at least one surface of the transparent substrate, and a plurality of electrode trace patterns, wherein the plurality of electrode trace patterns are disposed under the non-active area; and a polarizing layer disposed on the touch detection unit.

In addition, a display device, according to one embodiment of the present disclosure, may include: a display panel, a polarizing layer disposed on the display panel, and a window disposed on the polarizing layer, wherein the polarizing layer including a first polarizing layer and at least one second polarizing layer disposed below the first polarizing layer, and an electrode pattern of a touch detection unit is patterned on at least one surface of the second polarizing layer.

The display device, according to one embodiment of the present disclosure, improves non-visibility of the electrode patterns of a touch detection unit by using anti-reflection polarizing films and carbon-free manufacturing.

Further, according to one embodiment of the present disclosure, it is possible to improve non-visibility of the electrode patterns of a touch detection unit by adjusting the refractivity of light by patterning a flexible nano-wire electrode in a polarizing layer area. Also, due to this, the thickness of the display device may be reduced.

In addition, according to one embodiment of the present disclosure, the electrode pattern of the touch detection unit includes a relatively long pattern formed by a nano-wire electrode with a low resistance, and a relatively short pattern formed by an Indium Tin Oxide (ITO) electrode with a high resistance, thereby maximizing a touch performance effect. It is possible to reduce the bezel of left/right trace pattern areas by using Rx-Tx touch electrodes in two different layers of the nano-wire/ITO.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view illustrating the front of an electronic device according to one embodiment of the present disclosure;

FIG. 2 is a perspective view illustrating the back of the electronic device according to one embodiment of the present disclosure;

FIG. 3 is a front view illustrating the front of the electronic device according to one embodiment of the present disclosure;

FIG. 4 is a sectional view illustrating the outer periphery of a display device in the related art;

FIG. 5 is a sectional view illustrating the vertical stack structure of the display device in the related art;

FIG. 6 is a sectional view illustrating the outer peripheral area of a display device according to one embodiment of the present disclosure;

FIG. 7 is a sectional view illustrating the vertical stack structure of the display device according to one embodiment of the present disclosure;

FIG. 8 is a sectional view illustrating another display device according to one embodiment of the present disclosure;

FIG. 9 is a sectional view illustrating yet another display device according to one embodiment of the present disclosure;

FIG. 10A is a table illustrating the deviation between nodes of a touch detection unit in the related art;

FIG. 10B is a table illustrating the deviation between nodes of a touch detection unit according to one embodiment of the present disclosure;

FIG. 11 is a sectional view illustrating the outer peripheral area of a display device according to one embodiment of the present disclosure;

FIG. 12 is a sectional view illustrating another display device according to one embodiment of the present disclosure;

FIG. 13 is a sectional view illustrating yet another display device according to one embodiment of the present disclosure;

FIG. 14 is a sectional view illustrating yet another display device according to one embodiment of the present disclosure;

FIG. 15 is a sectional view illustrating yet another display device according to one embodiment of the present disclosure; and

FIG. 16 is a block diagram of an electronic device according to one embodiment of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

As used herein, the expression “A or B”, “at least one of A and/or B”, or “one or more of A and/or B” may include any or all possible combinations of items enumerated together. For example, “A or B,” “at least one of A and B,” or “at least one of A or B” may refer to all cases of (1) including at least one A, (2) including at least one B, or (3) including both at least one A and at least one B.

The expressions “a first,” “a second,” “the first,” “the second,” and the like, used in various embodiments, may modify various elements irrespective of order and/or importance thereof and do not limit the corresponding elements. The above-described expressions may be used to distinguish an element from another element. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The expression “configured to” may not necessarily mean “specially designed to” in terms of hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical terms and scientific terms, may have the same meaning as commonly understood by a person of ordinary skill in the art to which the present disclosure pertains. Terms, such as those defined in commonly used dictionaries, should be interpreted as having a meaning that is the same or similar to their meaning in the context of the relevant art and will not be interpreted in an idealized or overly formal sense unless expressly so defined herein. In some cases, even the term defined in the present disclosure should not be interpreted to exclude embodiments of the present disclosure.

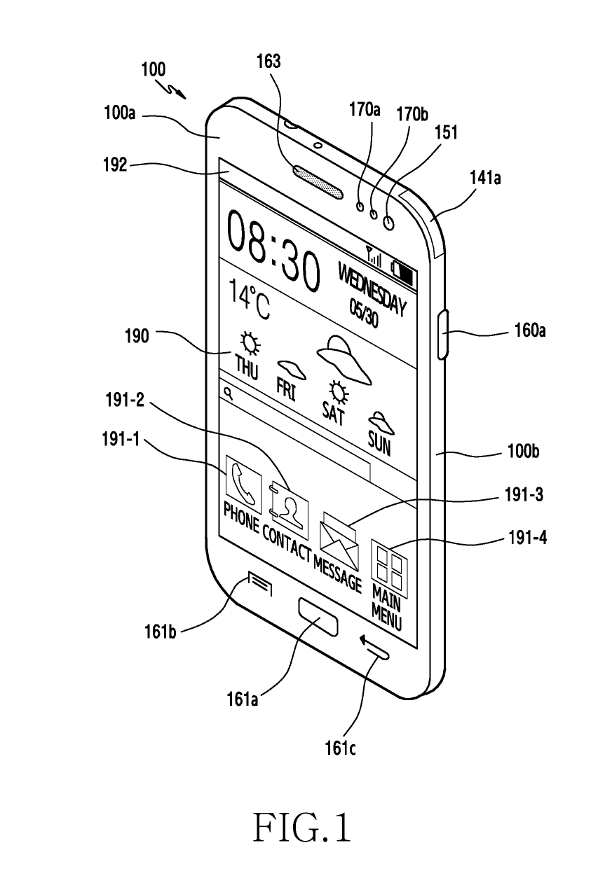

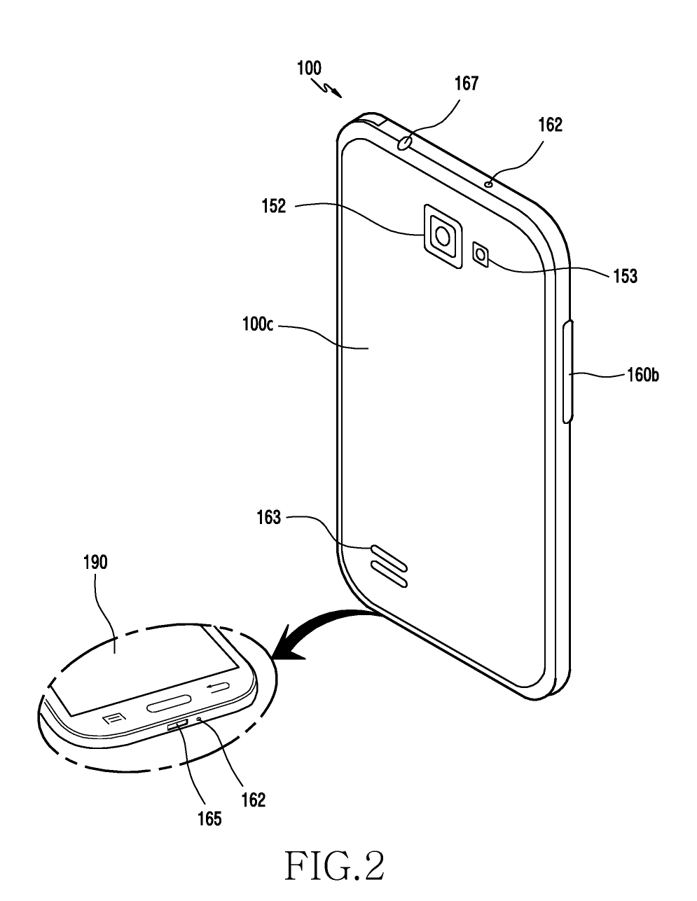

FIG. 1 is a perspective view illustrating the front of an electronic device according to one embodiment of the present disclosure. FIG. 2 is a perspective view illustrating the back of the electronic device according to one embodiment of the present disclosure.

Referring to FIGS. 1 and 2, the electronic device, according to one embodiment of the present disclosure, may include, for example, at least one of a smart phone, a tablet personal computer (PC), a mobile phone, a video phone, an e-book reader, a desktop PC, a laptop PC, a net-book computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic appcessory, electronic tattoos, a smart mirror, or a smart watch).

A display device that includes a touch screen 190 may be disposed in the middle of the front 100a of the electronic device 100 according to one embodiment of the present disclosure. The touch screen 190 may be formed to be large in size to occupy almost the entire front 100a of the electronic device 100. FIG. 1 shows an illustration in which the main home screen is displayed on the touch screen 190. The main home screen may be the first screen that is displayed on the touch screen 190 when the electronic device 100 is turned on. Further, in a case where the electronic device 100 has several pages of different home screens, the main home screen may be the first of the several pages of home screens. Shortcut icons 191-1,191-2, and 191-3 for executing frequently used applications, a main menu switching key 191-4, time, weather, and the like may be displayed on the home screen. The main menu switching key 191-4 may be used to display a menu screen on the touch screen 190. On the top of the touch screen 190, a status bar 192 may display the states of the electronic device 100, such as the battery charging state, the strength of a received communication signal such as a cellular signal or a WiFi signal, and the current time. A home button 161a, a menu button 161b, and a back button 161c may be formed on the bottom of the touch screen 190.

The home button 161a is used to display the main home screen on the touch screen 190. For example, when the home button 161a is touched while a screen that is different from the main home screen is displayed on the touch screen 190, the main home screen may be displayed on the touch screen 190. Further, when the home button 161a is touched while applications are executed on the touch screen 190, the main home screen, illustrated in FIG. 1, may be displayed on the touch screen 190. In addition, the home button 161a may be used to display recently used applications, or a task manager, on the touch screen 190. For example, a long-press of the home button 161a may be detected to display recently used applications. Alternatively, a double-press of the home button 161a may be detected.

The menu button 161b may be used to provide a connectivity menu that may be displayed on the touch screen 190. The connectivity menu may include a widget addition menu, a background switching menu, a search menu, an editing menu, an environment setting menu, etc. The back button 161c may be used to display the screen that was executed immediately before the currently displayed screen or to end the most recently used application.

A first camera 151, an illuminance sensor 170a, and a proximity sensor 170b may be disposed in the outer peripheral area of the front 100a of the electronic device 100 according to the various embodiments of the present disclosure. A second camera 152, a flash 153, and a speaker 163 may be disposed on the back 100c of the electronic device 100.

In one embodiment, a power/reset button 160a, a volume button 160b, a terrestrial DMB antenna 141a for receiving a broadcast, and one or more microphones 162 may be disposed on the lateral side 100b of the electronic device 100. The DMB antenna 141a may be secured to the electronic device 100, or may be built to be detachably coupled to the electronic device 100.

Further, a connector 165 is formed on the bottom of the electronic device 100. The connector 165 may have a plurality of electrodes formed therein, and may be connected to an external device in a wired manner. An earphone connecting jack 167 may be disposed on the top of the electronic device 100. The plug of earphones may be inserted into the earphone connecting jack 167. The earphone connecting jack 167 may also be disposed on the bottom of the electronic device 100.

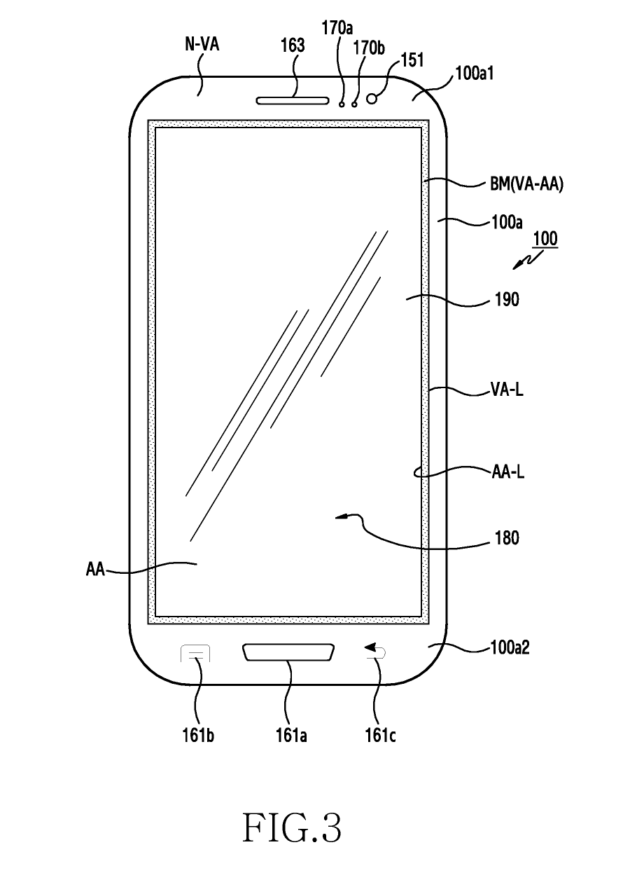

FIG. 3 is a front view illustrating the front of the electronic device according to one embodiment of the present disclosure.

Referring to FIG. 3, the display device 180 may be disposed in almost the entire area of the front 100a of the electronic device 100 according to one embodiment of the present disclosure. A speaker 163, the first camera 151, the illuminance sensor 170a, and the proximity sensor 170b may be disposed on the upper side 100a1 of the front 100a of the electronic device. The home button 161a, the menu button 161b, and the back button 161c may be formed on the lower side 100a2 of the front 100a of the electronic device. Components to be disposed on the upper or lower side 100a1 or 100a2 of the front of the electronic device may vary according to the performance or model type of the electronic device.

The display device 180 (including the touch screen) may have view area VA and a non-view area N-VA, and the view area VA may be further divided into an active area AA and a non-active area. Reference numeral VA-L may refer to the boundary line between the non-view area

N-VA and the view area VA, and reference numeral AA-L may refer to the boundary line between the view area VA and the active area AA. In particular, the view area VA may include the non-active area VA-AA (black matrix (BM) area) that is shown to a user in the view area VA, and the active area AA may refer to an area where data is displayed by the activation or operation of the display device 180. The non-active area between the two lines VA-L and AA-L may be shown to the user in black.

Hereinafter, the configuration of the display device will be described in detail with reference to drawings.

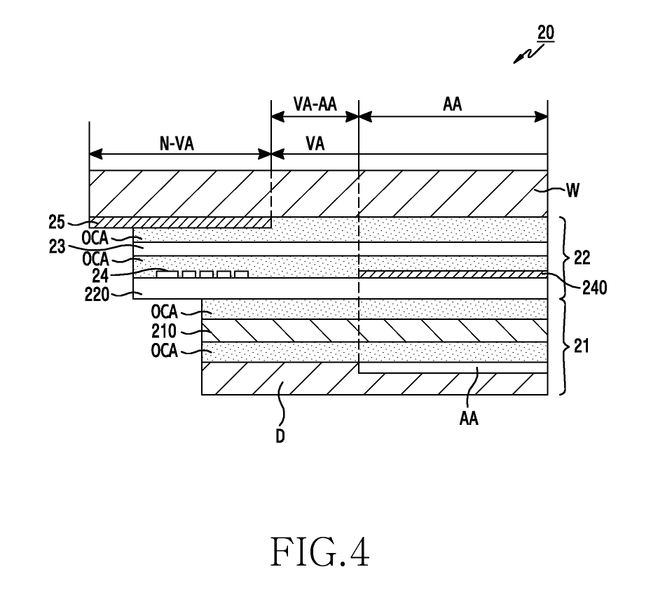

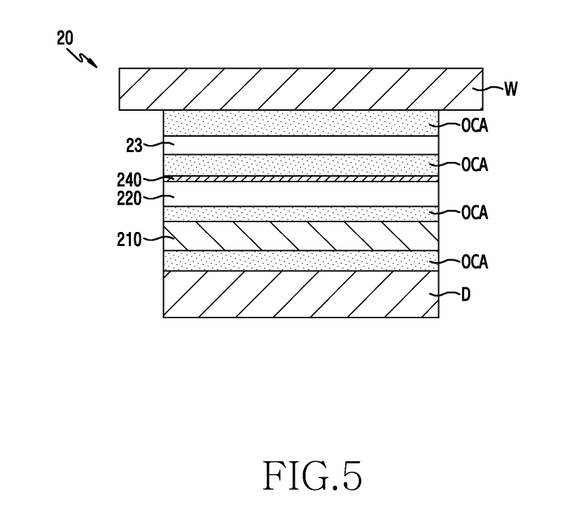

FIG. 4 is a sectional view illustrating the outer periphery of a display device in the related art. FIG. 5 is a sectional view illustrating the vertical stack structure of the display device in the related art.

Referring to FIGS. 4 and 5, the display device 20 in the related art may include a display unit 21, a window W, and a touch detection unit 22. The window W may be disposed in the uppermost position. The touch detection unit 22 may be disposed below the window W, and the display unit 21 may be disposed below the touch detection unit 22.

The window W may include a printed layer 25 formed along the outer periphery of the bottom thereof. A view area VA and a non-view area N-VA may be distinguished from each other by the printed layer 25. In other words, the view area VA may be masked or defined by the printed layer 25.

The touch detection unit 22 may include a protection film 23 and a sensing film 220, and an electrode pattern 240 may be disposed on the sensing film 220. A plurality of electrode trace patterns 24 may be disposed on the outer periphery of the sensing film 220. The electrode trace patterns 24 may be disposed below the printed layer 25, so that the electrode trace patterns 24 are not visible to the user. The display unit 21 may include a display panel D and a polarizing layer 210 disposed on the display panel D. The display panel D and the polarizing layer 210 may be attached to each other by an optically clear adhesive (OCA), and the polarizing layer 210 and the sensing film 220 may also be integrally attached to each other by an OCA. The sensing film 220 and the protection film 23 may be integrally attached to each other by an OCA, and the protection film 23 may be integrally attached to the window W by an OCA.

However, the display device 20 with the above-described structure has a limitation where the bezel of the display must be a certain size to accommodate the electrode trace patterns 24. The electrode trace patterns 24 cannot be disposed in the non-active area VA-AA because the electrode trace patterns 24 may be visible to the user if it is disposed in the non-active area.

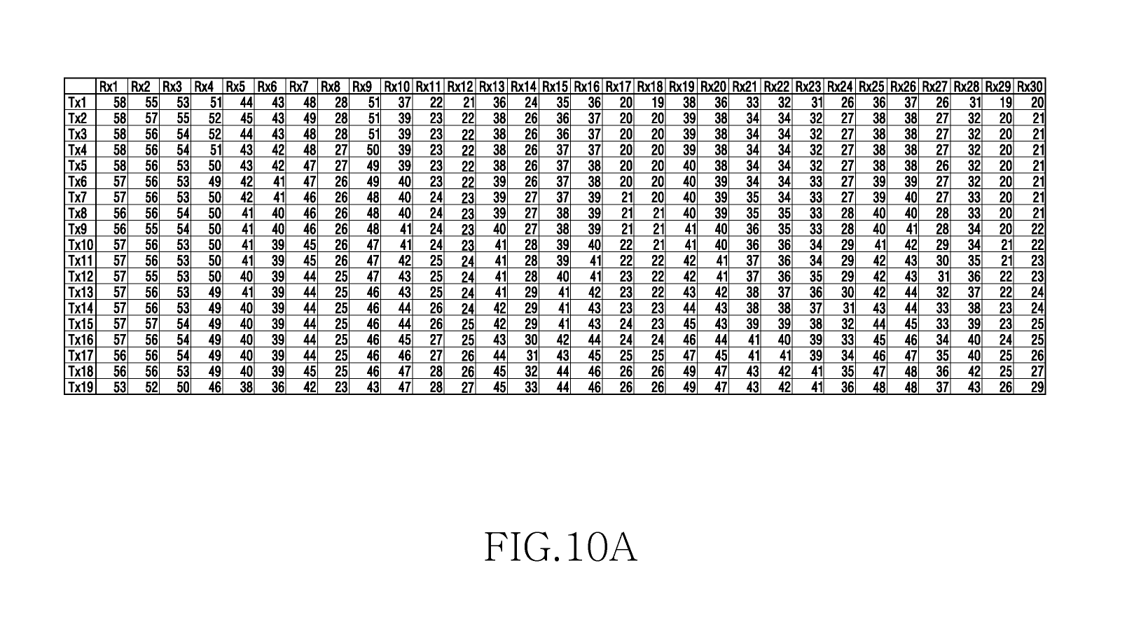

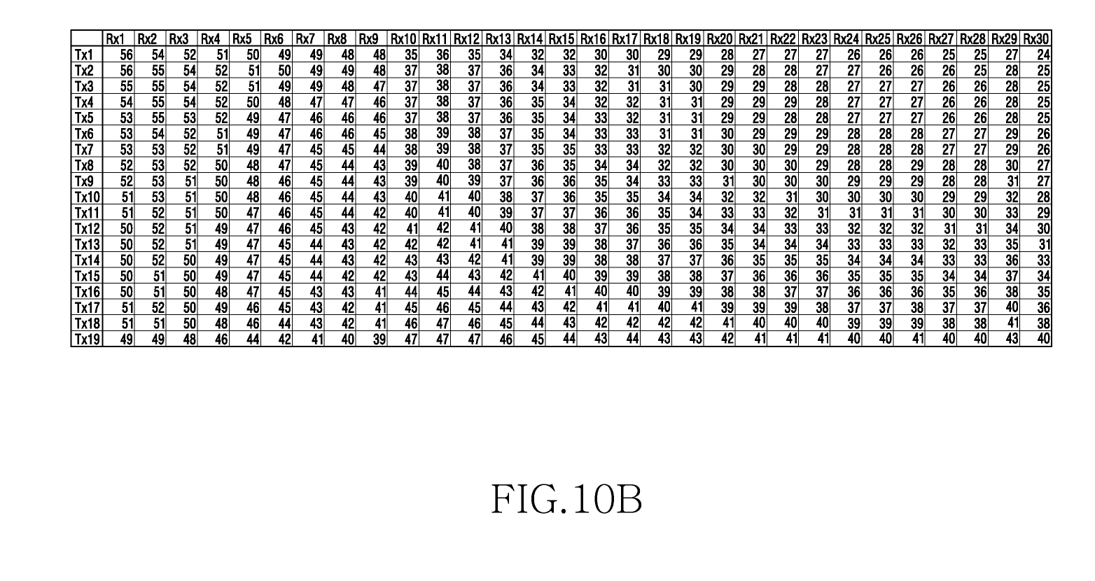

In addition, a small amount of conductive material (such as carbon) that is contained in the non-active area VA-AA has an influence on the capacitance value detected by the touch detection unit 22. Therefore disposing the electrode trace patterns 24 in non-active area may introduce sensing errors (see FIG. 10A).

Hereinafter, a display device, according to various embodiments of the present disclosure, which is capable of solving the above technical problem, will be described with reference to the accompanying drawings. Specifically, a display device with improved performance that may have a reduced non-active area and may be made slimmer than the conventional display device will be described.

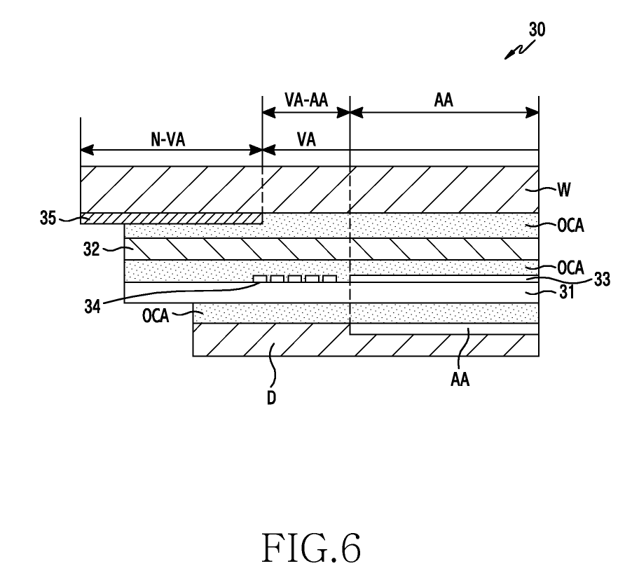

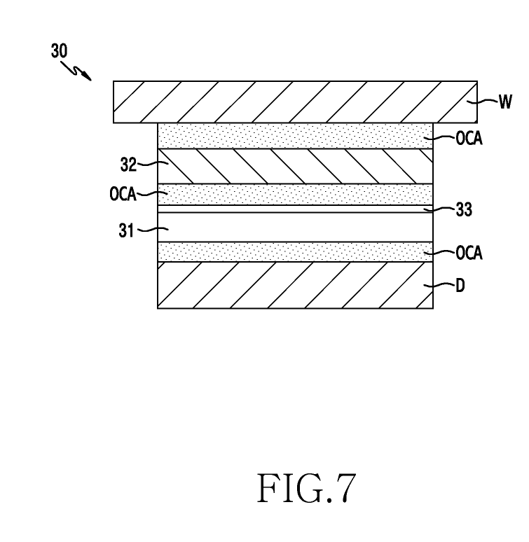

First, the configuration of a display device 30, according to one embodiment of the present disclosure, will be hereinafter described with reference to FIGS. 6 and 7.

FIG. 6 is a sectional view illustrating the outer peripheral area of the display device according to one embodiment of the present disclosure. FIG. 7 is a sectional view illustrating the vertical stack structure of the display device according to one embodiment of the present disclosure.

Referring to FIGS. 6 and 7, the display device 30, according to one embodiment of the present disclosure, is configured with a thin film transistor liquid crystal display (TFT-LCD), an organic light emitting diode (OLED), or an active matrix organic light emitting diode (AMOLED). However, the display device 30 is not limited thereto. For example, in addition to the aforementioned thin film transistor liquid crystal display or organic light emitting diode, any device capable of displaying information on a screen may be used as the display panel D of the display device 30.

The display device 30, according to the various embodiments, may be divided into a view area VA that is shown to a user and a non-view area N-VA that is not shown to the user. Further, the view area VA of the display device 30 (including a touch screen) may an active area AA and a non-active area VA-AA. In particular, the view area VA may include a non-active area VA-AA (which may be called a BM area herein) that is shown to the user, and the active area AA may include an area where data is displayed by the activation or operation of the display device 30. In one embodiment, the non-active area may be shown as a black boundary or edge around the active area AA. The active area AA may be at least a part of the view area VA. The active area AA may have a rectangular shape, and the view area VA may be an area that surrounds the outer periphery of the active area AA. Further, the non-view area N-VA may be an area that surrounds the outer periphery of the view area VA. Electrode trace patterns 34, or a portion thereof, according to the present disclosure, may be disposed to be under with the non-active area VA-AA.

The display device 30, according to one embodiment, may include the display panel D, a window W, a polarizing layer 32, and a transparent substrate 31. The window W may be disposed in the uppermost position. The polarizing layer 32 and the transparent substrate 31 may be disposed below the window W, and the display panel D may be disposed below the transparent substrate 31.

The window W may be formed of a transparent material, and an opaque printed layer 35 may be formed along the outer periphery of the bottom of the window W. The front of the electronic device may be divided into the view area VA and the non-view area N-VA by the printed area.

The polarizing layer 32 may be attached to the bottom of the window W by an OCA. The transparent substrate 31 may be attached to the bottom of the polarizing layer 32 by an OCA. The polarizing layer 32 may be provided above the transparent substrate 31 and may be stacked on the bottom of the window W in order to obtain linear polarization of the light passing through the polarizing layer 32. A coating film (not illustrated) may be integrally coated on the polarizing layer 32 in order to decrease a reflectivity or to restrict light scattering or surface reflection. The coating film may include at least one of anti reflective (AR), low reflective (LR), anti glare (AG), and hard coat (HC). However, the configuration of the polarizing layer 32 in this embodiment is not limited to the listed configurations, and the listed configurations may include other complex coatings on the polarizing layer 32. For example, various modified embodiments are possible, such as coating AR and AG on the polarizing layer 32, coating LR and AG on the polarizing layer 32, or coating the polarizing layer 32 with various types of materials according to properties of light such as scattering, refraction, reflection, etc.

A touch detection unit, according to one embodiment, may be formed on the transparent substrate 31. The touch detection unit may include a plurality of electrode patterns 33 formed on at least one surface of the transparent substrate 31. In particular, the plurality of electrode patterns 33 may be formed on the top and/or bottom of the transparent substrate 31. In addition, the plurality of electrode trace patterns 34 of the touch detection unit may be formed on the top and/or bottom of the transparent substrate 31. In particular, the plurality of electrode trace patterns 34 may be formed over the non-view area N-VA below the printed layer 35 and/or the non-active area VA-AA. In this case, carbon-free insulating printing may be performed on the non-view area N-VA or on the non-active area VA-AA.

The transparent substrate 31 may be formed of a material (e.g., glass, plastic, etc.) with rigidity, i.e. a non-resilient material, a resilient material that can be curved, bent, or folded, or a film made of a flexible material. For example, the flexible material may include at least one of polycarbonate (PC), polyethylene terephthalate (PET), cyclo olefin polymer (COP), cyclo olefin copolymer (COC), polyimide (PI), a polymer compound, and olefin. However, the material of the transparent substrate 31 is not limited thereto, and any material suitable for the present disclosure may be used. Further, the transparent substrate 31 may be formed in a film or sheet shape that is a thin film layer shape.

The display panel D and the transparent substrate 31 may be integrally attached to each other by an OCA, and the transparent substrate 31 and the polarizing layer 32 may also be integrally attached to each other by an OCA. The polarizing layer 32 may be integrally attached to the window W by an OCA.

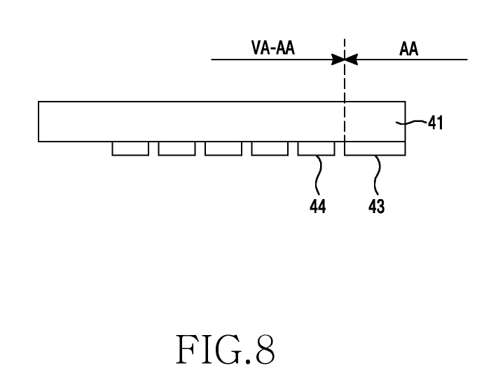

FIG. 8 is a sectional view illustrating another display device according to one embodiment of the present disclosure.

Referring to FIG. 8, a plurality of electrode trace patterns 44 and a plurality of electrode patterns 43, according to various embodiments, may be formed on the bottom of a transparent substrate 41. The plurality of electrode trace patterns 44 and the plurality of electrode patterns 43 may also be formed or disposed on the top of the transparent substrate (not shown in FIG. 8). The plurality of electrode trace patterns 44 may be formed on the bottom of the transparent substrate that corresponds to the non-active area VA-AA.

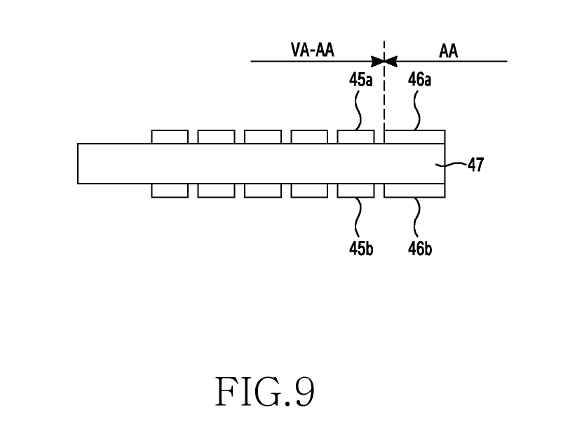

FIG. 9 is a sectional view illustrating yet another display device according to one embodiment of the present disclosure.

Referring to FIG. 9, the plurality of electrode trace patterns 45a and 45b and the plurality of electrode patterns 46a and 46b, according to one embodiment of the present disclosure, may be formed on the top and bottom of a transparent substrate 47. The plurality of electrode trace patterns 45a and 45b may be formed on the top and bottom of the transparent substrate that correspond to the non-active area VA-AA.

FIGS. 10A and 10B are tables that illustrate physical touch performance of a display device according to presence or absence of a carbon material. FIG. 10A is a table illustrating touch performance of a display device with carbon in the BM area thereof in the related art, and FIG. 10B is table illustrating touch performance of a display device with no carbon in the BM area thereof according to an embodiment of the present disclosure. As illustrated in FIGS. 10A and 10B, when the BM area contains carbon, node values of the touch detection unit may fluctuate so that there are deviations between nodes, which causes errors. But, as shown in FIG. 10B, when the BM area does not contain carbon, the deviation between nodes of the touch detection unit is greatly reduced.

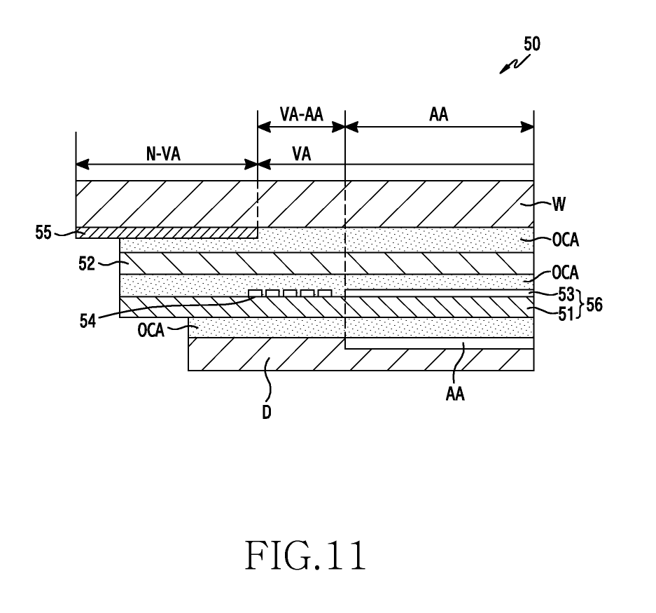

FIG. 11 is a sectional view illustrating the outer peripheral area of a display device according to one embodiment of the present disclosure.

Referring to FIG. 11, the display device 50, according to the one embodiment of the present disclosure, may include a display panel D, a window W, a first polarizing layer 52, a second polarizing layer 51, and a touch detection unit 56. The window W may be disposed in the uppermost position. The first and second polarizing layers 52 and 51 and the touch detection unit 56 may be disposed below the window W, and the display panel D may be disposed below the second polarizing layer 51.

The window W may be formed of a transparent material, and a printed layer 55 forming an opaque printed area may be formed along the outer periphery of the bottom of the window W. The front of the electronic device may be divided into a view area VA and a non-view area N-VA by the printed area.

The first polarizing layer 52 may be attached to the bottom of the window W by an OCA. The second polarizing layer 51 may be attached to the first polarizing layer 52 by an OCA. The first polarizing layer 52 may be provided above the second polarizing layer 51 and may be stacked on the bottom of the window W in order to obtain linear polarization of the light passing through the polarizing layer 32. A coating film (not illustrated) may be integrally coated on the first polarizing layer 52 in order to decrease a reflectivity or to restrict light scattering or surface reflection. The coating film may include at least one of anti reflective (AR), low reflective (LR), anti glare (AG), and hard coat (HC). Further, the second polarizing layer 51 may include a polarizing member with a phase difference, a polarizing member with no phase difference, or an isotropic optical member.

However, the configuration of the first polarizing layer 52 in this embodiment is not limited to the listed configurations, and the listed configurations may include other complex coatings on the first polarizing layer 52. For example, various modified embodiments are possible, such as coating AR and AG on the first polarizing layer 52, coating LR and AG on the first polarizing layer 52, coating the first polarizing layer 52 with various types of materials according to properties of light such as scattering, refraction, reflection, etc.

The second polarizing layer 51 may be attached by an OCA to the bottom of the first polarizing layer 52 and may be attached to the top of the display panel D by an OCA. The touch detection unit may be disposed on at least one surface of the second polarizing layer 51. The touch detection unit may include a plurality of electrode patterns 53 and electrode trace patterns 54 that are formed on at least one surface of the second polarizing layer 51.

The plurality of electrode patterns 53 may be formed on the top and bottom of the second polarizing layer 51, or may be formed on the top or bottom of the second polarizing layer 51. In addition, the plurality of electrode trace patterns 54 may be formed on the top and bottom of the second polarizing layer 51, or may be formed on the top or bottom of the second polarizing layer 51. Further, the plurality of electrode trace patterns 54 may be formed in the non-view area N-VA below the printed area and on the second polarizing layer 51 that corresponds to the non-active area VA-AA.

In one embodiment of the present disclosure, the second polarizing layer 51, on which the electrode patterns 53 and the electrode trace patterns 54 are patterned, may be constituted by a λ/4 polarizing member (e.g., an optical film). The material of the λ/4 polarizing member may include at least one of polycarbonate (PC), polyethylene terephthalate (PET), cyclo olefin polymer (COP), cyclo olefin copolymer (COC), polyimide (PI), a polymer compound, and olefin. However, the second polarizing layer 51 is not limited to the λ/4 polarizing member or the material thereof as in this embodiment. For example, the second polarizing layer 51 may be constituted by a λ/2 polarizing member, or a λ/4 and λ/2 polarizing member, rather than the λ/4 polarizing member according to the configuration or stack structure of the display device 50. Further, the material of the second polarizing layer 51 is not limited thereto, and any suitable material capable of allowing the patterns 53 to be formed may be used for the second polarizing layer 51.

Further, an opaque metal electrode (such as a metal mesh, a nano-mesh, a metal wire mesh, a nano-wire mesh, etc.) may be employed for the electrode patterns 53. Namely, the metal mesh, nano-mesh, metal wire mesh, or nano-wire mesh is an opaque electrode that contains a metal material (such as silver, carbon, graphene, aluminum, copper, etc.) that can conduct electricity. However, the material of the metal mesh, nano-mesh, metal wire mesh, or nano-wire mesh is not limited thereto, and any material that may make an electrical connection, have a low resistance value, and form a pattern to make it possible to recognize a touch may be used for the same.

Since the electrode patterns 53, according to several embodiments of the present disclosure, are constituted by the nano-mesh, metal mesh, nano-wire mesh, or metal wire mesh that is formed of opaque metal (such as, silver, carbon, graphene, copper, aluminum, etc.), the electrode patterns 53 must be visible to a user by reflecting and scattering light.

However, the electrode patterns 53 (such as the nano-mesh, metal mesh, nano-wire mesh, or metal wire mesh) are integrally stacked in the display device 50, so the electrode patterns 53 are not visible to the user by refraction, scattering, or reflection of light. Namely, since the first and second polarizing layers 52 and 51 are plate-shaped structures that transmit light that oscillates in one direction, natural light input through the window W may prevent the patterns 53 from being visible to the user while being reflected and scattered by the first polarizing layer 52, the second polarizing layer 51, and the display panel D in a serial order. Specifically, vertical and horizontal natural light is input to the first polarizing layer 52 through the window W, and the input light has a vertical or horizontal orientation while passing through the first polarizing layer 52 and is input to the second polarizing layer 51. The light having one orientation is deformed while passing through the second polarizing layer 51 and is reflected by the display panel D. The light reflected by the display panel D is deformed to have one orientation while passing through the second polarizing layer 51. The reflected light having one orientation fails to pass through the first polarizing layer 52, which prevents the electrode patterns 53, which are patterned on the second polarizing layer 51, from being visible to the user. Accordingly, the electrode patterns 53 are not visually recognized by the user, thereby improving visibility.

Further, according to one embodiment of the present disclosure, a relatively long pattern may form a nano-wire electrode with a low resistance, and a relatively short pattern may form an ITO electrode with a high resistance, thereby maximizing a touch performance effect. The touch detection unit may be more effective in reducing the bezel of left/right trace pattern areas by using Rx-Tx touch electrodes in two different layers of the nano-wire/ITO.

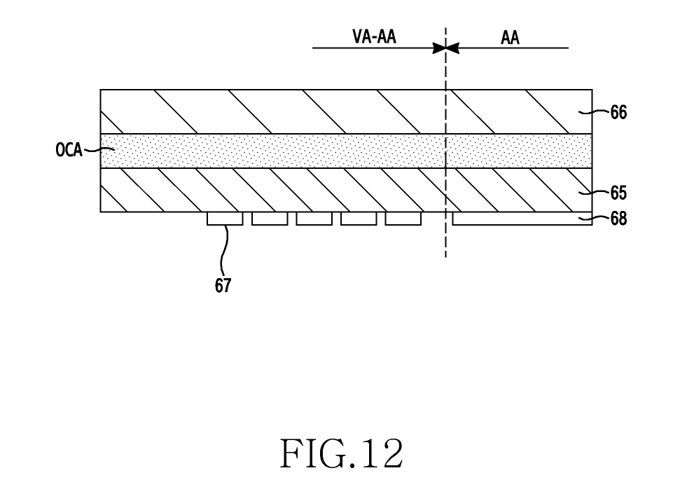

FIG. 12 is a sectional view illustrating another display device according to one embodiment of the present disclosure.

Referring to FIG. 12, a plurality of electrode patterns 68 may be formed on the bottom of a polarizing layer 65 according to one embodiment. Further, a plurality of electrode trace patterns 67 may be formed on the bottom of the polarizing layer 65, which corresponds to the non-active area VA-AA.

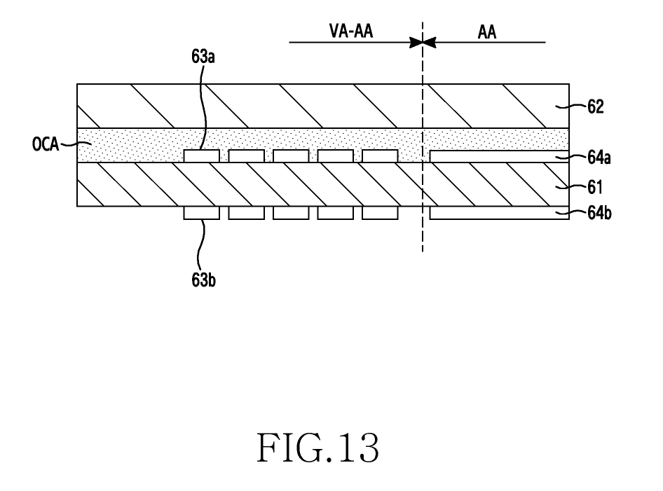

FIG. 13 is a sectional view illustrating yet another display device according to one embodiment of the present disclosure.

Referring to FIG. 13, a plurality of electrode patterns 64a and 64b may be formed on the top and bottom of a polarizing layer 61 according to various embodiments. Further, a plurality of electrode trace patterns 63a and 63b may be formed on the top and bottom of the polarizing layer 61, which corresponds to the non-active area VA-AA.

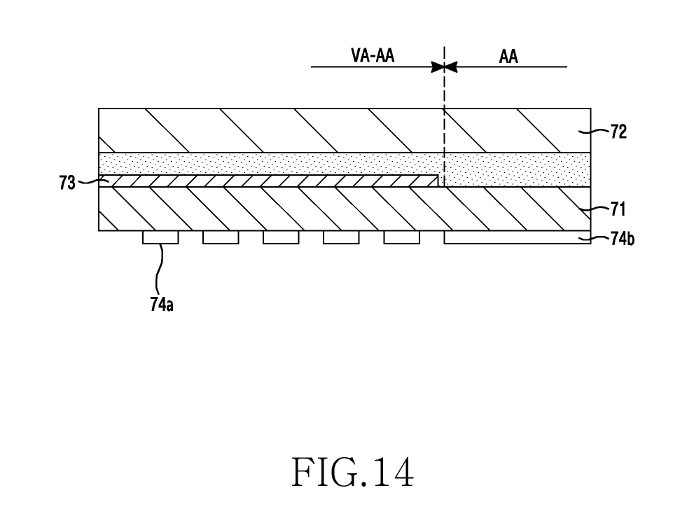

FIG. 14 is a sectional view illustrating yet another display device according to one embodiment of the present disclosure.

Referring to FIG. 14, a first shielding layer 73 may be disposed on the top of a polarizing layer 71 according to one embodiment, and a plurality of electrode patterns 74b may be formed on the bottom of the polarizing layer 71. Further, a plurality of electrode trace patterns 74a may be formed on the bottom of the polarizing layer 71, which corresponds to the non-active area VA-AA. The first shielding layer 73 may be disposed in a layer form to have an area that is sufficient to cover the plurality of electrode trace patterns 74a.

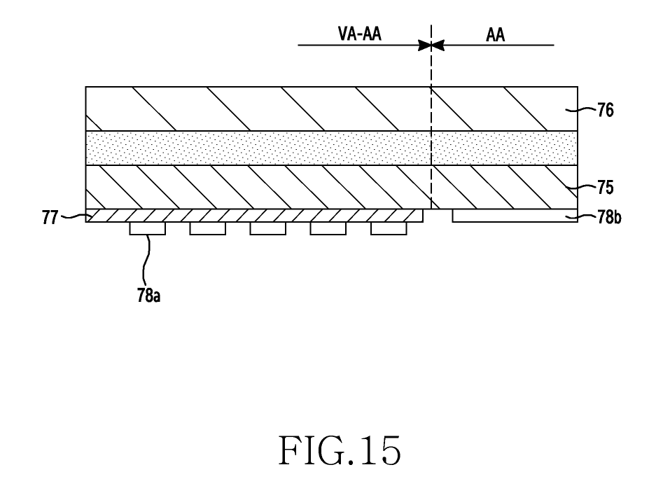

FIG. 15 is a sectional view illustrating yet another display device according to one embodiment of the present disclosure.

Referring to FIG. 15, a second shielding layer 77 may be disposed on the bottom of a polarizing layer 75 according to various embodiments, and a plurality of electrode patterns 78b may be formed on the bottom of the second shielding layer 77. Further, a plurality of electrode trace patterns 78a may be formed on the bottom of the second shielding layer 77, which corresponds to the non-active area VA-AA. The second shielding layer 77 may be disposed in a layer form to have an area that is sufficient to cover the plurality of electrode trace patterns 78a.

The shielding layers illustrated in FIGS. 14 and 15 may have a via-hole formed in the view area to serve as a mask in a UV-exposure process. Accordingly, among electrodes Tx and Rx formed on the top and bottom of a transparent substrate or a phase-difference polarizing layer, one electrode may be connected to the electrode trace patterns in the same plane, and the other electrode on the opposite side may be connected to the electrode trace patterns through the via hole.

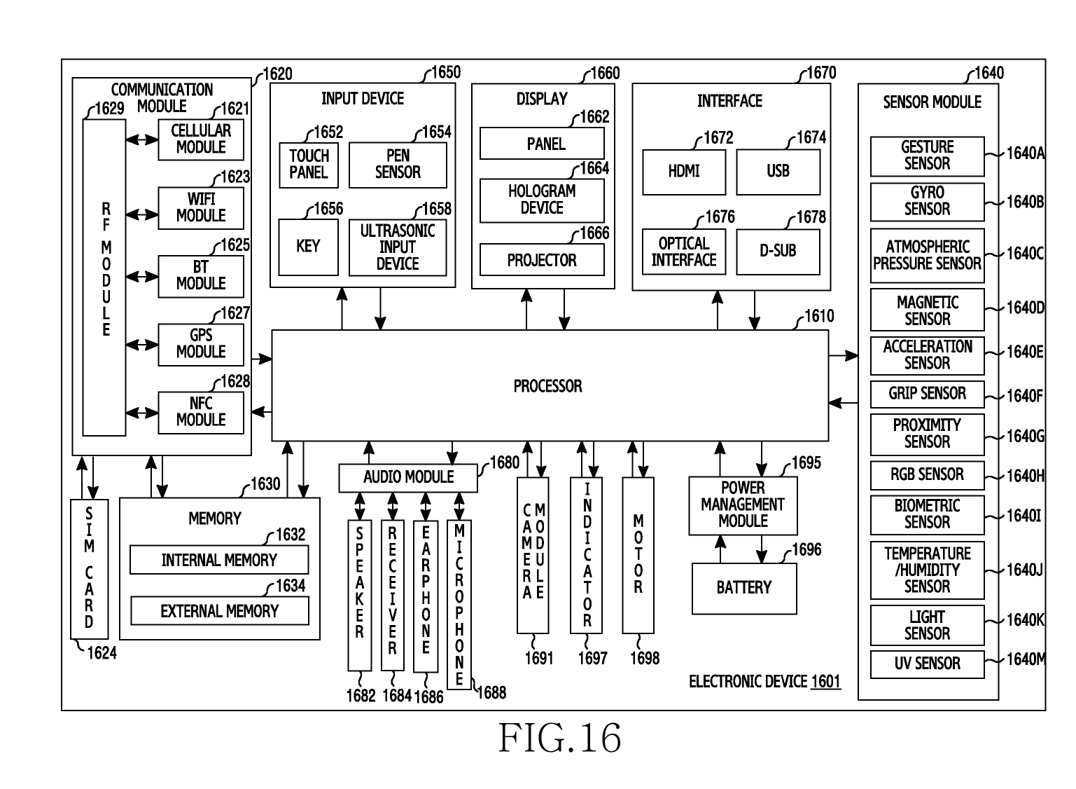

FIG. 16 is a block diagram of an example of an electronic device, according to the present disclosure.

Referring to FIG. 16, the electronic device 1601 includes an application processor (AP) 1610, a communication module 1620, a subscriber identification module (SIM) card 1624, a memory 1630, a sensor module 1640, an input device 1650, a display 1660, an interface 1670, an audio module 1680, a camera module 1691, a power management module 1695, a battery 1696, an indicator 1697, and a motor 1698, among other components.

The AP 1610 runs an operating system or an application program to control a plurality of hardware or software constituent elements of the electronic device 1601, and may perform processing and operation of various data including multimedia data. The AP 1610 may be, for example, implemented as a system on chip (SoC). According to an embodiment of the present invention, the AP 1610 further includes a graphical processing unit (GPU). The AP 1610 further includes at least one of other constitute elements (e.g., the cellular module 1621). The AP 1610 loads an instruction or data, which is received from a non-volatile memory connected to each or at least one of other constituent elements, to a volatile memory and processes the loaded instruction or data. In addition, the AP 1610 stores in the non-volatile memory, data received from at least one of the other constituent elements or generated by at least one of the other constituent elements.

The communication module 1620 performs data transmission/reception in communication between the electronic device 1601 and other electronic devices connected through a network. According to an embodiment of the present invention, the communication module 1620 includes cellular module 1621, a WiFi module 1623, a BT module 1625, a GPS module 1627, an NFC module 1628, and a radio frequency (RF) module 1629.

The cellular module 1621 provides a voice telephony, a video telephony, a text service, an Internet service, and the like, through a telecommunication network (e.g., LTE, LTE-A, CDMA, WCDMA, UMTS, WiBro, GSM, and the like). In addition, the cellular module 1621 may, for example, use a SIM card 1624 to perform electronic device distinction and authorization within the telecommunication network. According to an embodiment of the present invention, the cellular module 1621 may perform at least some of functions that the AP 1610 may provide. For example, the cellular module 1621 performs at least one part of a multimedia control function.

The WiFi module 1623, the BT module 1625, the GPS module 1627 and the NFC module 1628 each may include, for example, a processor for processing data transmitted/received through the corresponding module. According to an embodiment of the present invention, at least some (e.g., two or more) of the cellular module 1621, the WiFi module 1623, the BT module 1625, the GPS module 1627 and the NFC module 1628 are included within one IC or IC package.

The RF module 1629 performs transmission/reception of data, for example, transmission/reception of an RF signal. The RF module 1629 may include, for example, a transceiver, a power amplifier module (PAM), a frequency filter, a low noise amplifier (LNA), an antenna and the like. According to an embodiment of the present invention, at least one of the cellular module 1621, the WiFi module 1623, the BT module 1625, the GPS module 1627 or the NFC module 1628 may perform transmission/reception of an RF signal through a separate RF module.

The SIM card 1624 includes a SIM, and may be inserted into a slot provided in a specific position of the electronic device 1601. The SIM card 1624 includes unique identification information (e.g., an integrated circuit card ID (ICCID)) or subscriber information (e.g., an international mobile subscriber identity (IMSI)).

The memory 1630 includes an internal memory 1632 or an external memory 1634. The internal memory 1632 includes, for example, at least one of a volatile memory (e.g., a dynamic random access memory (DRAM), a static RAM (SRAM) and a synchronous DRAM (SDRAM)) or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, and a not or (NOR) flash memory). For example, the memory 1630 may be a hard drive or a solid-state drive.

According to an embodiment of the present invention, the internal memory 1632 may be a solid state drive (SSD). The external memory 1634 may further include a flash drive, for example, compact flash (CF), secure digital (SD), micro-SD, mini-SD, extreme digital (xD), a memory stick, and the like. The external memory 1634 may be operatively connected with the electronic device 1601 through various interfaces.

The sensor module 1640 measures a physical quantity or detects an activation state of the electronic device 101, and converts measured or detected information into an electric signal. The sensor module 1640 includes, for example, at least one of a gesture sensor 1640A, a gyro sensor 1640B, an air pressure sensor 1640C, a magnetic sensor 1640D, an acceleration sensor 1640E, a grip sensor 1640F, a proximity sensor 1640G, a color sensor 1640H (e.g., a red, green, blue (RGB) sensor), a bio-physical sensor 1640I, a temperature/humidity sensor 1640J, an illumination sensor 1640K, a ultraviolet (UV) sensor 1640M, and the like. Additionally or alternatively, the sensor module 1640 may also include, for example, an E-nose sensor, an electromyography (EMG) sensor, an electroencephalogram (EEG) sensor, an electrocardiogram (ECG) sensor, an infrared (IR) sensor, an iris sensor, a fingerprint sensor, and the like. The sensor module 1640 may further include a control circuit for controlling at least one or more sensors belonging therein.

The input device 1650 includes a touch panel 1652, a (digital) pen sensor 1654, a key 1656, an ultrasonic input device 1658, and the like. The touch panel 1652 may, for example, detect a touch input in at least one of a capacitive overlay scheme, a pressure sensitive scheme, an infrared beam scheme, and an acoustic wave scheme. The touch panel 1652 may also include a control circuit. In a case of the capacitive overlay scheme, physical contact or proximity detection is possible. The touch panel 1652 may further include a tactile layer, to provide a tactile response to a user.

The (digital) pen sensor 1654 may be implemented in the same or similar method to receiving a user's touch input or by using a separate sheet for detection. The key 1656 may include, for example, a physical button, an optical key, or a keypad. The ultrasonic input device 1658 is capable of identifying data by detecting a sound wave in the electronic device 1601 through an input tool generating an ultrasonic signal, and enables wireless detection. According to an embodiment of the present invention, the electronic device 1601 may also use the communication module 1620 to receive a user input from a connected external device (e.g., a computer or a server).

The display 260 includes a panel 1662, a hologram device 1664, or a projector 1666. The panel 1662 may be, for example, an LCD, an Active-Matrix Organic LED (AMOLED), and the like. The panel 1662 may be, for example, implemented to be flexible, transparent, or wearable. The panel 1662 may be constructed as one module along with the touch panel 1652 as well. The hologram device 1664 may use interference of light to show a three-dimensional image in the air. The projector 1666 may project light to a screen to display an image. The screen may be, for example, located inside or outside the electronic device 1601. According to an embodiment of the present invention, the display 1660 may further include a control circuit for controlling the panel 1662, the hologram device 1664, or the projector 1666.

The interface 1670 includes, for example, a high-definition multimedia interface (HDMI) 1672, a universal service bus (USB) 1674, an optical interface 1676, or a D-subminiature (D-sub) 1678. Additionally or alternatively, the interface 1670 includes, for example, a mobile high-definition link (MHL) interface, an SD card/multimedia card (MMC) interface or an infrared data association (IrDA) standard interface.

The audio module 1680 converts a voice and an electric signal interactively. The audio module 1680 may, for example, process sound information which is inputted or outputted through a speaker 1682, a receiver 1684, an earphone 1686, the microphone 1688, and the like.

The camera module 1691 takes still pictures and moving pictures. According to an embodiment of the present invention, the camera module 1691 includes one or more image sensors (e.g., a front sensor or a rear sensor), a lens, an image signal processor (ISP), or a flash (e.g., an LED or a xenon lamp).

The power management module 1695 manages electric power of the electronic device 1601. The power management module 1695 includes, for example, a power management integrated circuit (PMIC), a charger IC, a battery, a battery gauge, and the like.

The PMIC may be, for example, mounted within an integrated circuit or an SoC semiconductor. A charging scheme may be divided into a wired charging scheme and a wireless charging scheme. The charger IC charges the battery 1696, and prevents the inflow of overvoltage or overcurrent from an electric charger. According to an embodiment of the present invention, the charger IC includes a charger IC for at least one of the wired charging scheme or the wireless charging scheme. The wireless charging scheme may, for example, be a magnetic resonance scheme, a magnetic induction scheme, an electromagnetic wave scheme, and the like. A supplementary circuit for wireless charging, for example, a circuit, such as a coil loop, a resonance circuit, a rectifier, and the like, may be added.

The battery gauge may, for example, measure a level of the battery 1696, a voltage during charging, a current or a temperature. The battery 1696 generates or stores electricity, and uses the stored or generated electricity to supply power to the electronic device 1601. The battery 1696 may include, for example, a rechargeable battery or a solar battery.

The indicator 1697 displays a specific status of the electronic device 1601 or one part (e.g., the AP 1610) thereof, for example a booting state, a message state, a charging state, and the like. The motor 1698 may convert an electric signal into a mechanical vibration. The electronic device 1601 may include a processing device (e.g., a GPU) for mobile TV support. The processing device for mobile TV support may, for example, process media data according to the standards of digital multimedia broadcasting (DMB), digital video broadcasting (DVB), a media flow, and the like.

Each of the above-described elements of the electronic device may include one or more components, and the name of a corresponding element may vary according to the type of electronic device. The electronic device according to the present invention may include at least one of the above-described elements and may exclude some of the elements or further include other additional elements. Further, some of the elements of the electronic device according to the present invention may be coupled to form a single entity while performing the same functions as those of the corresponding elements before the coupling.

The term “module” or “unit,” as used herein may represent, for example, a unit including a combination of one or two or more of hardware, software, or firmware. The “module” may be, for example, used interchangeably with the terms “unit”, “logic”, “logical block”, “component”, or “circuit” etc. The “module” may be the minimum unit of an integrally constructed component or a part thereof. The “module” may be also the minimum unit performing one or more functions or a part thereof. The “module” may be implemented mechanically or electronically. For example, the “module” may include at least one of an application-specific integrated circuit (ASIC) chip, Field-Programmable Gate Arrays (FPGAs) and a programmable-logic device performing some operations known to the art or to be developed in the future.

At least a part of an apparatus (e.g., modules or functions thereof) or method (e.g., operations) according to the present invention may be, for example, implemented as instructions stored in a computer-readable storage medium in a form of a programming module. In case that the instruction is executed by a processor, and the processor may perform functions corresponding to the instructions. The computer-readable storage media may be the memory 130, for instance.

The computer-readable recording medium may include a hard disk, a floppy disk, and a magnetic medium (e.g., a magnetic tape), an optical medium (e.g., a Compact Disc-Read Only Memory (CD-ROM) and a Digital Versatile Disc (DVD)), a Magneto-Optical Medium (e.g., a floptical disk), and a hardware device (e.g., a Read Only Memory (ROM), a Random Access Memory (RAM), a flash memory, etc.). Also, the program instruction may include not only a mechanical language code such as a code made by a compiler but also a high-level language code executable by a computer using an interpreter, etc. The aforementioned hardware device may be constructed to operate as one or more software modules in order to perform operations of the present invention, and vice versa.

The module or programming module according to the present invention may include at least one or more of the aforementioned constituent elements, or omit some of the aforementioned constituent elements, or further include additional other constituent elements. Operations carried out by the module, the programming module or the other constituent elements according to the present invention may be executed in a sequential, parallel, repeated or heuristic method. Also, some operations may be executed in different order or may be omitted, or other operations may be added.

Accordingly, a method and electronic device are provided for controlling a display according to the present invention, to determine the priority of display based on a user's preference, thereby being able to decrease a search time for display and more quickly display a desired screen.

While the present disclosure has been shown and described with reference to certain embodiments thereof, it will be apparent to those skilled in the art that the camera lens module according to the present disclosure is not limited to these embodiments, and various changes in form and details may be made therein without departing from the spirit and scope of the present disclosure as defined by the appended claims.

What is claimed is:

1. A display device comprising:
a window having a printed area formed along an outer periphery thereof;
a display panel disposed below the window to provide a view area including an active area where data is displayed and a non-active area; and
a touch detection unit disposed between the window and the display panel,
wherein a plurality of electrode trace patterns of the touch detection unit are disposed under the non-active area.

2. The display device of claim 1, wherein carbon-free low-transmittance insulating printing is performed on the non-active area.

3. The display device of claim 2, wherein the plurality of electrode trace patterns are disposed under the printed area.

4. The display device of claim 1, further comprising:
a polarizing layer disposed between the window and the display panel; and
a transparent substrate disposed between the polarizing layer and the display panel,
wherein the plurality of electrode trace patterns are disposed on a top of the transparent substrate, on a bottom of the transparent substrate, or on the top and bottom of the transparent substrate.

5. The display device of claim 1, further comprising:
a polarizing layer disposed between the window and the display panel,
wherein the plurality of electrode trace patterns are disposed on a top of the polarizing layer, on a bottom of the polarizing layer, or on the top and bottom of the polarizing layer.

6. The display device of claim 2, further comprising:
a first polarizing layer disposed between the window and the display panel;
at least one second polarizing layer disposed below the first polarizing layer,
wherein the plurality of electrode trace patterns are disposed on a top of the second polarizing layer, on a bottom of the second polarizing layer, or on the top and bottom the second polarizing layer; and
a shielding layer formed on the top or bottom of the second polarizing layer.

7. The display device of claim 6, wherein a first shielding layer is formed on the top of the second polarizing layer, and the plurality of electrode trace patterns are disposed on the bottom of the second polarizing layer opposite the first shielding layer.

8. The display device of claim 6, wherein a second shielding layer is formed on the bottom of the second polarizing layer, and the plurality of electrode trace patterns are formed on the bottom of the second polarizing layer.

9. The display device of claim 6, wherein the second polarizing layer comprises at least one of a polarizing member with a phase difference, a polarizing member with no phase difference, and an isotropic optical member.

10. A display device comprising:
a window having a printed area formed along an outer periphery thereof;
a display panel disposed below the window to provide a view area including an active area where data is displayed and a non-active area;
a touch detection unit disposed on the display panel, the touch detection unit includes:
a transparent substrate,
an electrode pattern disposed on at least one surface of the transparent substrate, and
a plurality of electrode trace patterns, wherein the plurality of electrode trace patterns are disposed under the non-active area; and
a polarizing layer disposed on the touch detection unit.

11. The display device of claim 10, wherein the electrode pattern is disposed on a top of the transparent substrate, on a bottom of the transparent substrate, or on the top and bottom of the transparent substrate.

12. The display device of claim 10, wherein a top of the transparent substrate is attached to the polarizing layer by a first optically clear adhesive, and a bottom of the transparent substrate is attached to the display panel by a second optically clear adhesive.

13. The display device of claim 10, wherein the transparent substrate comprises at least one of a rigid material and a curved, foldable, or bendable material.

14. The display device of claim 10, wherein the transparent substrate comprises at least one of a glass material and a plastic material.

15. The display device of claim 10, wherein the transparent substrate comprises a film, and the film comprises at least one of polycarbonate (PC), polyethylene terephthalate (PET), cyclo olefin polymer (COP), cyclo olefin copolymer (COC), polyimide (PI), a polymer compound, and olefin.

16. A display device comprising:
a display panel;
a polarizing layer disposed on the display panel; and
a window disposed on the polarizing layer,
wherein the polarizing layer includes a first polarizing layer and at least one second polarizing layer disposed below the first polarizing layer, and an electrode pattern of a touch detection unit is patterned on at least one surface of the second polarizing layer.

17. The display device of claim 16, wherein the electrode pattern is disposed on a top of the second polarizing layer, on a bottom of the second polarizing layer, or on the top and bottom of the second polarizing layer, wherein a shielding layer is disposed on the top or bottom of the second polarizing layer.

18. The display device of claim 17, wherein a first shielding layer is disposed on the top of the second polarizing layer, and the electrode pattern is disposed on the bottom of the second polarizing layer.

19. The display device of claim 17, wherein a second shielding layer is formed on the bottom of the second polarizing layer, and the electrode pattern is also disposed on the bottom of the second shielding layer.

20. The display device of claim 16, wherein the second polarizing layer comprises one of a λ/4 polarizing member, a λ/2 polarizing member, and a λ/2 and λ/4 polarizing member,
wherein the λ/4 polarizing member and/or the λ/2 polarizing member comprises at least one of polycarbonate (PC), polyethylene terephthalate (PET), cyclo olefin polymer (COP), cyclo olefin copolymer (COC), polyimide (PI), a polymer compound, and olefin.
